(19) United States
(12) Patent Application Publication
(10) Pub. No.: US 2026/0296489 A1
(43) Pub. Date: Oct. 1, 2026

(54) SYSTEMS AND METHODS FOR PROBABILISTIC MOTION PLANNING IN AUTONOMOUS VEHICLES

(71) Applicant: AVRIDE Inc., Newburyport, MA (US)

(72) Inventors: Mikhael Afanasenko, Austin, TX (US); Roman Udovichenko, Austin, TX (US)

(21) Appl. No.: 19/577,727

(22) Filed: Mar. 25, 2026

Related U.S. Application Data
(60) Provisional application No. 63/777,188, filed on Mar. 25, 2025.

(51) Int. Cl. B60W 60/00; B60W 50/00; B60W 50/14

(52) U.S. Cl. CPC B60W 60/001; B60W 50/0098; B60W 50/14; B60W 2050/0028; B60W 2050/146; B60W 2556/40

(57) ABSTRACT

Provided herein is a system and method for probabilistic motion planning in autonomous vehicles, the system including: at least one processor; and a memory communicatively connected to the at least one processor, wherein the memory contains instructions configuring the at least one processor to: receive a telemetry data set and a position dataset; generate as a function of the telemetry dataset, the position dataset, and a trajectory projection algorithm, a plurality of projected trajectories, wherein the plurality of projected trajectories each include a plurality of trajectory points associated with probabilities; combine the plurality of projected trajectories at a temporal point to determine a probabilistic occupancy map; and generate a trajectory for an autonomous vehicle as a function of the probabilistic occupancy map and a route generation algorithm.

### CROSS REFERENCE TO RELATED APPLICATIONS

This application claims the benefit of priority to U.S. Provisional Application No. 63/777,188, filed on Mar. 25, 2025, and entitled “METHOD AND SYSTEM FOR PROBABILISTIC MOTION PLANNING IN AUTONOMOUS VEHICLES USING TEMPORAL POINT DISTRIBUTION ANALYSIS,” the entirety of which is incorporated herein by reference.

### FIELD OF THE INVENTION

The present invention is directed generally to a method and apparatus for motion planning in autonomous vehicles and, more particularly, to a method and system for probabilistic motion planning in autonomous vehicles.

### BACKGROUND OF THE INVENTION

Historically, conventional motion planning in autonomous vehicles evaluate individual trajectory hypotheses as discrete possibilities. However, these approaches employed historically fail to provide a comprehensive map that includes multiple trajectory distributions, which evidences a disadvantage in the efficiency of autonomous vehicle operations.

Therefore, the need exists for a method and system for probabilistic motion planning in autonomous vehicles that results in safer and more efficient autonomous vehicle operation.

Accordingly, there remains a need in the art for probabilistic motion planning in autonomous vehicles that improve upon existing systems and methods for motion planning. The present disclosure meets this need.

### SUMMARY

In some aspects, the techniques described herein relate to a system for probabilistic motion planning in autonomous vehicles, the system including: at least one processor; and a memory communicatively connected to the at least one processor, wherein the memory contains instructions configuring the at least one processor to: receive a telemetry data set and a position dataset; generate as a function of the telemetry dataset, the position dataset, and a trajectory projection algorithm, a plurality of projected trajectories, wherein the plurality of projected trajectories each include a plurality of trajectory points associated with probabilities; combine the plurality of projected trajectories at a temporal point to determine a probabilistic occupancy map; and generate a trajectory for an autonomous vehicle as a function of the probabilistic occupancy map and a route generation algorithm.

In some aspects, the techniques described herein relate to a method for probabilistic motion planning in autonomous vehicles, the method including: receiving, using at least one processor, a telemetry data set and a position dataset; generating, using the at least one processor, as a function of the telemetry dataset, the position dataset, and a trajectory projection algorithm, a plurality of projected trajectories, wherein the plurality of projected trajectories each include a plurality of trajectory points associated with probabilities; combining, using the at least one processor, the plurality of projected trajectories at a temporal point to determine a probabilistic occupancy map; and generating, using the at least one processor, a trajectory for an autonomous vehicle as a function of the probabilistic occupancy map and a route generation algorithm.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows an exemplary embodiment of a system for probabilistic motion planning in autonomous vehicles;

FIGS. 2A and 2B show an exemplary embodiment of a probabilistic occupancy map;

FIG. 3 shows another exemplary embodiment of a probabilistic occupancy map with vehicle trajectory;

FIGS. 4A and 4B show an exemplary vehicle computing architecture;

FIG. 5 shows an exemplary machine-learning module;

FIG. 6 shows an exemplary neural network;

FIG. 7 shows an exemplary method for probabilistic motion planning in autonomous vehicles; and

FIG. 8 shows a diagrammatic representation of one embodiment of a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a: b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

### DETAILED DESCRIPTION

In some embodiments, the present disclosure is directed to a method and system for motion planning in autonomous vehicles. In some embodiments, the present disclosure also includes a method of evaluating agent trajectory probabilities through a novel temporal point distribution approach.

Furthermore, in some embodiments, the present disclosure includes a system that aggregates multiple trajectory distributions at specific time points to create a comprehensive probabilistic occupancy map.

The present disclosure solves problems experienced with the prior art because it provides a method and system for probabilistic motion planning in autonomous vehicles that results in safer and more efficient autonomous vehicle operation. Those and other advantages and benefits of the present disclosure will become apparent from the detailed description of the invention hereinbelow.

### Generating Projected Trajectories

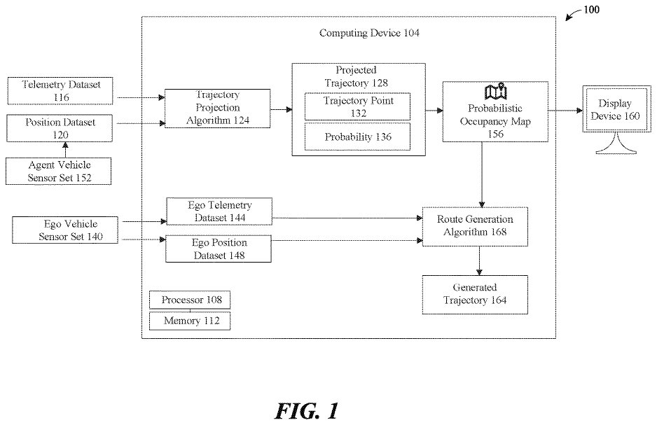

Referring now to FIG. 1, an exemplary embodiment of system 100 for probabilistic motion planning in autonomous vehicles is illustrated. System 100 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, system 100 includes at least a processor 108. System 100 includes a memory 112. Memory 112 is communicatively connected to processor 108. Memory 112 includes instructions configuring the at least a processor 108 to perform one or more actions or tasks as described in further detail throughout this disclosure.

With continued reference to FIG. 1, memory 112 may include instructions configuring processor 108 to receive telemetry dataset 116. A “telemetry dataset,” for the purposes of this disclosure, is a dataset of data collected using sensors on a vehicle. For example, and as non-limiting examples, telemetry dataset 116 may include speed, acceleration, LIDAR data, Radar data, ultrasound data, camera data, GPS data, brake data, detected object data, steering data, throttle data, fuel data, and the like.

With continued reference to FIG. 1, memory 112 may include instructions configuring processor 108 to receive a position dataset 120. A “position dataset,” for the purposes of this disclosure, is a dataset including position data for an autonomous detail. As non-limiting example, position dataset 120 may include GPS data, map location data, relative location data, spacing data, distance data coordinates, latitude and longitude, and the like. Position dataset 120 may include data locating an autonomous vehicle on a global level (e.g., using GPS data, coordinates, or latitude and longitude). In some embodiments, position dataset 120 may include local location data; as non-limiting examples, this may include positioning of a vehicle in a map, positioning of a vehicle relative two objects (such as other vehicles, cars, signs, road markings, pedestrians, or the like).

With continued reference to FIG. 1, memory 112 may include instructions configuring processor 108 to receive telemetry dataset 116 and/or position dataset 120 from a vehicle sensor set. Vehicle sensor set may include, as non-limiting examples, cameras, LIDAR, radar, ultrasonic sensors, microphones, and GPS. Vehicle sensor set may be located on an autonomous vehicle. Autonomous vehicle may include an autonomous car. An “autonomous vehicle,” for the purposes of this disclosure, is a device that is configured to move people or objects from one location while being primarily controlled by computerized algorithms rather than the input of a human. Autonomous vehicle may include a delivery robot. A “delivery robot,” for the purposes of this disclosure, is an autonomous vehicle that is configured to transport goods, but not humans. An “autonomous car,” for the purposes of this disclosure, is an autonomous vehicle that is configured to transport at least one human. Autonomous cars may include sedans, SUVs, motorbikes, trucks, pickup trucks, convertibles, crossovers, or the like.

With continued reference to FIG. 1, in some embodiments receiving telemetry dataset 116 and/or position dataset 120 may include receiving telemetry dataset 116 and/or position dataset 120 over a wireless connection. Wireless connection may include, as non-limiting examples, radio, cellular communication, line-of-sight communication, 2G, EDGE, 3G, 4G, LTE, 5G, WiFi, satellite communication, and the like.

With continued reference to FIG. 1, in some embodiments receiving telemetry dataset 116 and/or position dataset 120 may include receiving telemetry dataset 116 and/or position dataset 120 from a central server. For example, central server may be communicatively connected to the autonomous vehicles associated with telemetry dataset 116 and/or position dataset 120. In some embodiments, central server may be wirelessly connected to the autonomous vehicles associated with telemetry dataset 116 and/or position dataset 120. Central server may be communicatively connected to computing device 104 through a wired or wireless connection. Central server may collect and store data such as telemetry dataset 116 and/or position dataset 120 from autonomous vehicles.

With continued reference to FIG. 1, central server include or be communicatively connected to a database for storing the data from autonomous vehicles and/or the trajectories (projected or generated) for those autonomous vehicles. Database may be remote to computing device 104 and/or central server and communicative with computing device 104 and/or central server by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure computing device 104 and/or central server connect directly, dynamically, and non-hierarchically to as many other computing devices as possible. A “network topology” as used in this disclosure is an arrangement of elements of a communication network. database may be implemented, without limitation, as a relational database, a key-value retrieval database such as a NOSQL database, or any other format or structure for use as a database that a person skilled in the art would recognize as suitable upon review of the entirety of this disclosure. database may alternatively or additionally be implemented using a distributed data storage protocol and/or data structure, such as a distributed hash table or the like. database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, database may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain.

With continued reference to FIG. 1, in some embodiments, telemetry dataset 116 and or position dataset 120 may be generated by vehicle sensor sets located on another vehicle. For example, in some embodiments, vehicle sensor set may be located on an ego vehicle. In this case, vehicle sensor set may be referred to as ego vehicle sensor set 140. Ego vehicle sensor set 140 may be consistent with aspects of vehicle sensor sets as described throughout this disclosure. An “ego vehicle,” for the purposes of this disclosure, is the autonomous vehicle that is being controlled by autonomous driving algorithms and using a Probabilistic Occupancy Map or other projected trajectories for agents to generate its own trajectory. In some embodiments, ego vehicle sensor set 140 may collect data such as ego telemetry dataset 144 and/or ego position dataset 148. In some embodiments, ego telemetry dataset 144 may be consistent with telemetry dataset 116 as described throughout this disclosure. In some embodiments, dataset 148 may be consistent with position dataset 120 as described throughout this disclosure.

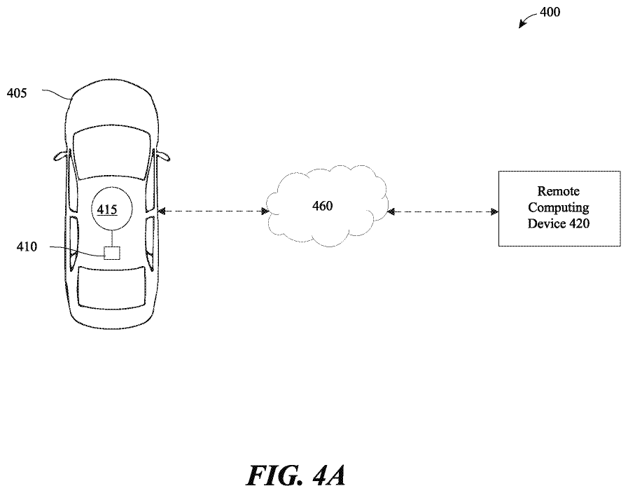

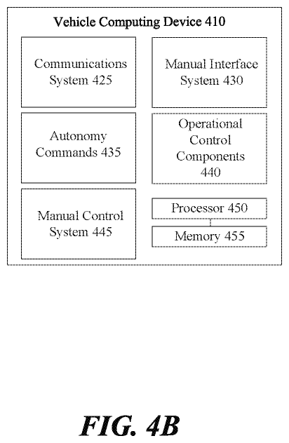

With continued reference to FIG. 1, in some embodiments, telemetry dataset 116 and position dataset 120 may be for an agent. An “agent,” in the context of autonomous vehicle algorithms, are other entities that are detected by or perceived by the ego vehicle. An agent may include, as non-limiting examples, other vehicles, other autonomous vehicles, signs, obstacles, pedestrians, animals, and the like. In some embodiments, in the context of data relating to an agent, telemetry dataset 116 may be called an agent telemetry dataset. In some embodiments, in the context of data relating to an agent, position dataset 120 may be called an agent position dataset. A vehicle sensor set located on or in an agent may be referred to as an agent vehicle sensor set 152. Agent vehicle sensor set 152 may be consistent with other vehicle sensor sets disclosed in this disclosure. Vehicle sensor sets may be further described with reference to FIGS. 4A and 4B.

With continued reference to FIG. 1, agent telemetry dataset and/or position telemetry dataset may be determined using an ego vehicle or ego vehicle sensor set 140. As a non-limiting example, ego vehicle sensor set 140 may detect or identify an agent and determine or estimate an agent position, velocity, acceleration, steering angle, or the like.

With continued reference to FIG. 1, memory 112 may include instructions configuring processor 108 to generate as a function of the telemetry dataset 116, the position dataset 120, and a trajectory projection algorithm 124, a plurality of projected trajectories 128. Plurality of projected trajectories 128.

With continued reference to FIG. 1, in some embodiments, generation of plurality of projected trajectories 128 may include using a feature extraction backbone. In some embodiments, a feature extraction backbone may be used to extract features from real-world data such as telemetry dataset 116 and/or position dataset 120. In some embodiments, features may be shared features that may be used on each head of a multi-task machine-learning model. Feature extraction backbone may be a shared feature-extraction backbone that is used by each head of the multi-task machine learning model. Feature extraction backbone may include a feature extractor; feature extractor may include a convolutional neural network (CNN), deep neural network (DNN), a vision transformer (ViT), resnet, multimodal feature extractors, or the like. In some embodiments, feature extraction backbone may extract features from telemetry dataset 116 and/or position dataset 120 and feed them to trajectory projection algorithm 124 as input.

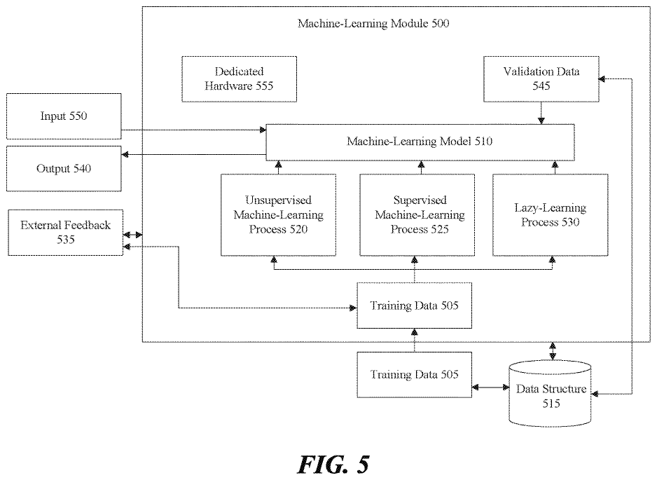

With continued reference to FIG. 1, trajectory projection algorithm 124 may include a trajectory prediction machine-learning model. Trajectory prediction machine-learning model may me configured to receive agent data as input and out a projected trajectory 128. In some embodiments, agent data may include telemetry dataset 116 and/or position dataset 120. In some embodiments, trajectory prediction machine-learning model may be trained using trajectory prediction training data. In some embodiments trajectory prediction training data may include real-world data (such as collected telemetry and position data) correlated to ground truth trajectories. In some embodiments, trajectory prediction training data may include previously collected data, such as data collected using vehicle sensor sets in the past. As such, vehicle sensor sets and data processing algorithms may collect the real (i.e. ground truth) trajectories of agents, from which trajectory prediction machine-learning model may be trained. Trajectory prediction machine-learning model may be configured to output with plurality of projected trajectories 128, points along the trajectory (e.g., plurality of trajectory points 132), and probabilities 136 associated with those points. Trajectory prediction machine-learning model may be trained using machine-learning module 500, discussed with reference to FIG. 5.

In some embodiments, plurality of projected trajectories 128 each may include a plurality of trajectory points 132 associated with probabilities 136. For example, trajectory points 132 may indicate points on the trajectory that the agent is projected to transit through. Probabilities may indicate a probability that an agent will occupy that space or point. In some embodiments, plurality of projected trajectories 128 may include temporal data regarding the trajectories. For example, each trajectory point 132 may be associated with a temporal point indicating the time at which an agent is predicted to be at the trajectory point 132.

With continued reference to FIG. 1, plurality of projected trajectories 128 may include a polyline trajectory. A “polyline trajectory,” for the purposes of this disclosure, is a way or representing motion as a sequence of interconnected, ordered line segments. In some embodiments, polyline trajectory may include a plurality of trajectory points 132; as a non-limiting example, wherein plurality of trajectory points 132 is an ordered set of points, a polyline trajectory may be constructed by connecting each point by a line segment in order. In some embodiments, each trajectory point 132 in projected trajectory 128 (or polyline trajectory) may be associated with probabilities and covariances.

### Probabilistic Occupancy Map

With continued reference to FIG. 1, memory 112 may include instructions configuring processor 108 to combine the plurality of projected trajectories 128 at a temporal point to determine a probabilistic occupancy map 156. A “probabilistic occupancy map,” for the purposes of this disclosure, is a spatial representation of an environment, where each location in the environment is assigned a probability that the location is occupied. In some embodiments, probabilities 136 from multiple trajectories may be overlayed or added together to form a comprehensive probabilistic occupancy map. For example, projected trajectory for a first agent and a projected trajectory for a second agent may include two sets or probability values for different spatial areas. These may be added together in order to provide a combined probabilistic occupancy map 156 taking into account the projected occupancy of the first and second agents. Therefore, this method can be extended to any number of agents to handle all agents detected by an ego vehicle.

With continued reference to FIG. 1, constructing probabilistic occupancy map 200 may include receiving a trajectory distribution (e.g., plurality of projected trajectories 128). Unlike deterministic models, each trajectory point may be treated as a Gaussian Mixture Model (GMM). For every future time step t, the agent's potential position is defined by a probability density function (PDF):

P(x_t)=Σw_i*N(x_t|μ_i,t,Σ_i,t)

Where w_i represents the weight of different maneuvers (e.g., a car might have an 80% chance of going straight and a 20% chance of turning left).

With continued reference to FIG. 1, construction of probabilistic occupancy map 156 may use temporal point distribution analysis as described throughout this disclosure. The “Temporal Point Distribution Analysis” may include calculating the Collision Probability P_coll for every candidate position p on the Rover's path at time t. The system may integrate the agent's GMM PDF over the expanded Minkowski region C centered at p:

P_coll(p,t)=∫[Σw_i*N(x|μ_i,t,Σ_i,t)] dx over the region C(p)

This step may effectively “sum up” the probability that the agent will be anywhere inside the zone that would cause a crash with the Rover at that specific time.

With continued reference to FIG. 1, because calculating a double integral over this area is computationally expensive for real-time applications, the system may employ Green's Theorem. This theorem reduces the double integral to a line integral along the boundary of the simply connected, piecewise-smooth domain. Since the density integral cannot be expressed in elementary functions, polynomial approximations are used to achieve the necessary computational efficiency for high-frequency planning cycles. Approximation is deployed into pipeline before it even will be started.

With continued reference to FIG. 1, by repeating this calculation for all positions and time steps, the system may determine a Probabilistic Occupancy Map 156. This map may be represented as a two-dimensional ST-Graph where the vertical axis represents the station (distance along the path) and the horizontal axis represents time. Instead of simple intersection checking, the Route Generation Algorithm 168 may use this grid to find a collision-optimal path. Cost-Based Planning: Each element or segment of the ST-graph may be assigned a cost proportional to its collision probability. Optimal Velocity Profile: the algorithm may search for a trajectory through the ST-space that minimizes the total risk while maintaining smooth acceleration and target speeds. Dynamic Response: if a certain time-slice shows high risk, the optimizer naturally adjusts the generated trajectory to slow the Rover down or introduce stop points until the probability of collision drops to a safe level.

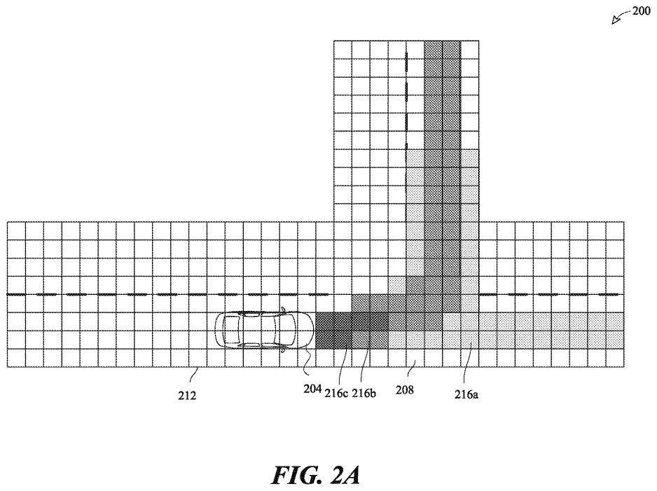

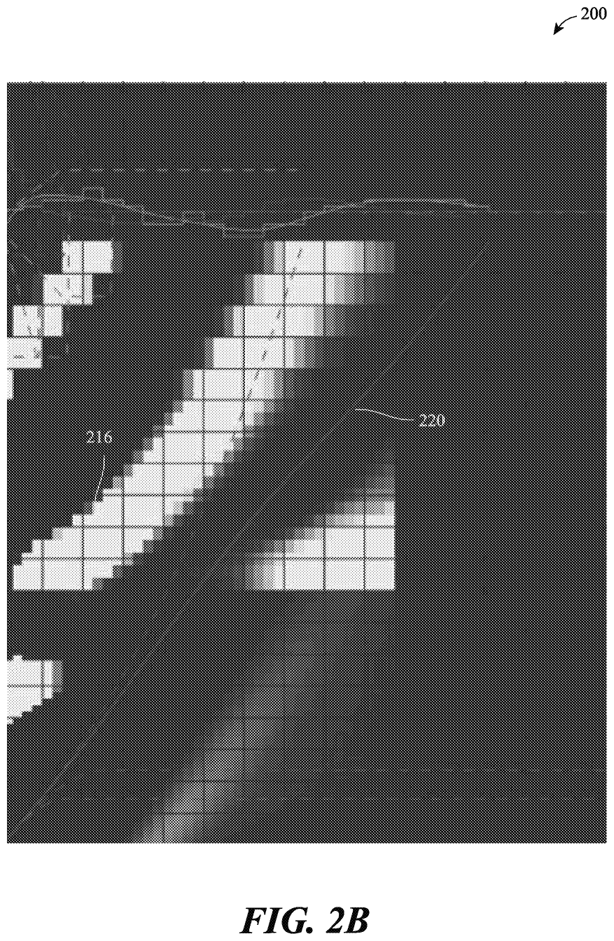

Referring now to FIG. 2A, an exemplary probabilistic occupancy map 200 is shown. Probabilistic occupancy map 200 may include an agent 204. Agent 204 may include a vehicle, car, robot, bike, pedestrian, animal, or the like. Probabilistic occupancy map 200 may include one or more squares 208. Squares 208 may be used to show discrete spatial areas of probabilistic occupancy map 200. Squares 208 are merely one example of how probabilistic occupancy map 200 may be discretized; as non-limiting examples, probabilistic occupancy map may be discretized into points, datums, or sectors. These examples, may be associated with occupancy probabilities as described with reference to FIG. 2A in a similar manner to squares 208.

With continued reference to FIG. 2A, in some embodiments, probabilistic occupancy map 200 may include a road 212. Road 212 may signify a path that is traversable by a vehicle. Road 212 may include various markings or restrictions that may govern or inform the navigation of agents or ego vehicles.

With continued reference to FIG. 2A, squares 208 may be associated with different probability values. For example, squares 208 may include a first probability value 216a, a second probability value 216b, and a third probability value 216c. As an illustrative example, first probability value 216a may indicate a lower probability value, second probability value 216b may indicate an intermediate probability value, and third probability value 216c may indicate a higher probability vale. Those skilled in the art, after having reviewed the entirety of this disclosure, would appreciate that any number of probability values and discretized divisions of probability values could be used in probabilistic occupancy map 200. In some embodiments, probability values may include a continuous range of probability values.

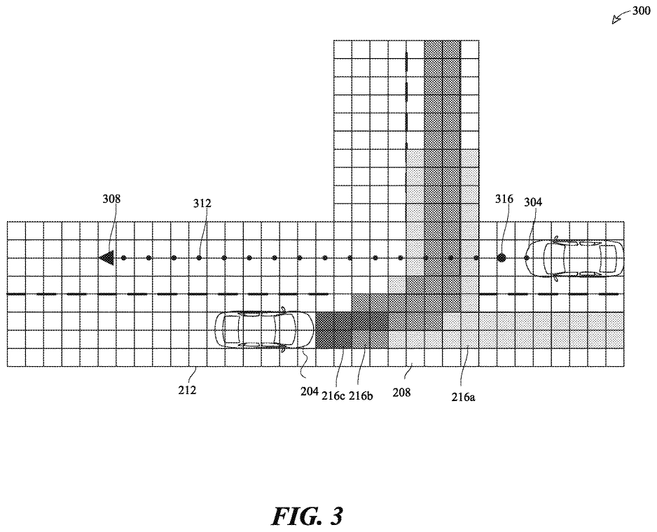

With continued reference to FIG. 2A, those skilled in the art, after having reviewed the entirety of this disclosure, would appreciate that probabilistic occupancy map 200 is provided merely as an illustration; in some embodiments, probabilistic occupancy map may include a data structure that is used by the appropriate algorithms and may never by rendered as human readable visualization as shown in FIGS. 2 and 3.

With continued reference to FIG. 2A, in some embodiments, different probability values (e.g., first probability value 216a, second probability value 216b, and third probability value 216c) may be mapped to different colors or shading to improve the visualization. In some embodiments, probability values may be mapped to a color range or range of shading to provide a continuous representation.

Referring now to FIG. 2B, another probabilistic occupancy map 200 is shown. Probabilistic occupancy map 200 includes various shaded probability values 216 as described further throughout this disclosure. In some embodiments, probabilistic occupancy map 200 may display or be used to determine a trajectory 220. Trajectory 220 may be consistent with generated trajectories as described throughout this disclosure.

Referring back to FIG. 1, memory 112 may include instructions configuring processor 108 to present probabilistic occupancy map 156 to a user through a display device 160. Display device may include a computing device with a screen, such as, but not limited to, a laptop, a tablet, a smartphone, an e reader, a smartwatch, an infotainment system, a center console, a navigation system, and the like. Display device 160 may include a screen such as, but not limited to, LED, LCD, plasma, CRT, OLED, e-ink, and the like.

### Generating Ego Trajectory

With continued reference to FIG. 1, memory 112 may include instructions configuring processor 108 to generate a trajectory for an ego vehicle using probabilistic occupancy map 156. Probabilistic occupancy map 156 may be integrated into one or more route generation algorithms used to generate trajectories for autonomous vehicles.

The probabilistic occupancy map 156 may be used by the route generation algorithms 168 through a process of Longitudinal Optimization (e.g., ST-graph planning). ST-graph planning includes mapping to spatio-temporal coordinates. In this case, route generation algorithm 168 may operate on an ST-graph, where the vertical axis represents the station (distance S along the fixed geometric path that has already been constructed before) and the horizontal axis represents time (T). The probabilistic occupancy map 156 may include multiple time-slices and provide a specific occupancy probability for every (S, T) coordinate. Route generation algorithm 168 may also include cost function assignment. For example, instead of treating agents as “hard” binary obstacles, the algorithm may assign a numerical cost to each element of the ST-space based on the calculated probability values. Areas with higher probabilities of occupancy (e.g., P>0.4) may be assigned significantly higher costs, effectively acting as “probabilistic obstacles” that the planner seeks to avoid.

With continued reference to FIG. 1, route generation algorithm 168 may generating trajectory 164 as a function of, at least in part, collision avoidance for the agents, e.g., using plurality of projected trajectories 128. To calculate a probability of a collision, the system may accounts for the physical dimensions of both the Ego Vehicle (Rover) and the Agent. As a non-limiting example, let rectangle R represent the geometry of the Rover and rectangle A represent the geometry of the Agent. The system may calculate the Minkowski Sum (@) of these two geometries: C=R⊕(−A). This transformation allows the Rover to be treated as a single point while the Agent's “collision footprint” is expanded to include all areas where any part of the Rover would overlap with any part of the Agent.

With continued reference to FIG. 1, memory 112 may include instructions configuring processor 108 to generate a trajectory 164 for an autonomous vehicle as a function of the probabilistic occupancy map 156 and a route generation algorithm 168. In some embodiments, when using probabilistic occupancy map 156, computing device 104 may evaluates agent trajectory probabilities through a temporal point distribution approach. In some embodiments, memory 112 may include instructions configuring processor 108 to generate the trajectory 164 for the autonomous vehicle and then check the trajectory 164 for the autonomous vehicle against probabilities 136 associated with one or more segments of the probabilistic occupancy map 156. In some embodiments, this may include determining a plurality of intersected segments of the probabilistic occupancy map 156 that are intersected by the trajectory 164. In some embodiments, then computing device 104 may adjust the trajectory against the probabilities 136 associated with the plurality of intersected segments. Segments may, in some embodiments, be consistent with squares 208 described with reference to FIGS. 2 and 3. For example, computing device 104 may check probabilities 136 of segments of probabilistic occupancy map 156 that are intersected by trajectory 164 against a probability threshold. If they exceed the probability threshold, then they processor 108 may recalculate trajectory 164 to avoid the segment or segments with the probabilities 136 that exceed the probability threshold.

With continued reference to FIG. 1, generating trajectory 164 as a function of probabilistic occupancy map 156 may include assigning a cost to an element of the probabilistic occupancy map 156 as a function of the probabilities 136. For example, when trajectory 164 is calculated, route generation algorithm 168 may seek to minimize a cost function to generate an optimal trajectory 164. Cost function may take into account various factors that would impact the trajectory 164; as non-limiting examples, this may include a length of the trajectory, traffic on the road, occupancy probabilities from probabilistic occupancy map 156, obstacles, or the like. In some embodiments, the cost assigned to the element of the probabilistic occupancy map 156 may increase a total cost of a trajectory that goes through the element of the probabilistic occupancy map 156, thereby discouraging the trajectory 164 that go through that element.

With continued reference to FIG. 1, probabilistic occupancy map 156 may include a plurality of probabilistic occupancy map 156 where each probabilistic occupancy map 156 represents a particular time slide. For example, probabilistic occupancy map 156 occupancy map at time t=1 s may represent the projected occupancy of agents 1 second into the future. For example, probabilistic occupancy map 156 occupancy map at time t=5 s may represent the projected occupancy of agents 5 seconds into the future. For example, probabilistic occupancy map 156 occupancy map at time t=10 s may represent the projected occupancy of agents 10 seconds into the future. When generating trajectory 164, route generation algorithm 168 may use the correct probability corresponding to the time slice where the ego vehicle would arrive at the probabilistic occupancy map 156 segment using the hypothetical trajectory. In other words, route generation algorithm 168, when evaluating trajectory 164, would use the occupancy probability for a point in space that is associated with the time at which the ego vehicle would occupy that point in space on the evaluated trajectory 164.

With continued reference to FIG. 1, in some embodiments, generating the probabilities 136 may include generating the probabilities 136 of the plurality of trajectory points 132 using a Kalman filter. In some embodiments, the Kalman filter may include propagating a state of an agent forward using a motion model. Kalman filter is an algorithm that uses a series of measurements observed over time, which may include statistical noise and other inaccuracies, to produce estimates of unknown variables that tend to be more accurate than those based on a single measurement, by estimating a joint probability distribution over the variables for each time-step.

With continued reference to FIG. 1, in some embodiments, generating the probabilities 136 may include generating the probabilities 136 of the plurality of trajectory points 132 using a Gaussian Mixture Model. A Gaussian Mixture Model (GMM) is a probabilistic model used to represent a complex distribution as a combination of several simpler, bell-shaped distributions called Gaussians (or normal distributions). Instead of assuming that your data comes from a single source, a GMM may assume that the data is generated by multiple underlying processes, each contributing in different proportions. When a datapoint is evaluated under a GMM it may not be assigned to just one Gaussian; Instead, a weighted sum, may be computed, of the probabilities from all the Gaussians. Each component may contribute according to both how likely the point is under that Gaussian and how large that component's weight is. This allows the model to represent complex, multimodal shapes, such as clusters that overlap or have different sizes and orientations.

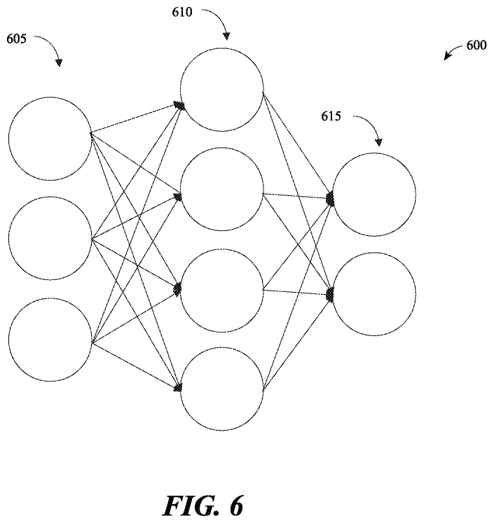

With continued reference to FIG. 1, in some embodiments, generating the probabilities 136 may include generating the probabilities 136 of the plurality of trajectory points 132 using a neural network. Neural networks, and the training thereof, are further described with reference to FIGS. 5 and 6. Neural network may be configured to output a probability. In some embodiments, neural network may be trained on data comprising ground truth data of agent's positions over time. In some embodiments, neural network may output a plurality of plurality of trajectories and associated probabilities. In some embodiments, neural network may include a gaussian mixture model. In some embodiments, neural network may include one or more gaussian mixture layers. A gaussian mixture layer may be configured to define parameters using gaussian mixtures.

In some embodiments, route generation algorithm 168 may receive ego telemetry dataset 144 and ego position dataset 148 as input when generating trajectory 164. In some embodiments, the autonomous vehicle which trajectory 164 is generated may include an autonomous car or delivery robot. In some embodiments, route generation algorithm route generation algorithm 168 may include a route generation machine learning model. Route generation machine-learning model may be configured to receive, as input, ego telemetry dataset 144, ego position dataset 148, and probabilistic occupancy map 156. Route generation machine-learning model may be configured to generate, as output, trajectory 164. In some embodiments, route generation machine-learning model may be trained using route generation training data. In some embodiments route generation training data may include real-world data (such as collected telemetry and position data) correlated to ground truth trajectories. In some embodiments, route generation training data may include previously collected data, such as data collected using vehicle sensor sets in the past. As such, vehicle sensor sets and data processing algorithms may collect the real (i.e. ground truth) trajectories of vehicles. Route generation machine-learning model may be trained using machine-learning module 500, discussed with reference to FIG. 5.

Referring now to FIG. 3, another exemplary embodiment of a probabilistic occupancy map in a view 300 with vehicle trajectory is shown. Probabilistic occupancy map may include agent 204, squares 208, road 212, first probability value 216a, second probability value 216b, and third probability value 216c as described with reference to FIG. 2A.

With continued reference to FIG. 3, view 300 may include an ego vehicle 304. Ego vehicle 304 may be the vehicle for which a trajectory is being generated for execution by ego vehicle 304. Ego vehicle trajectory 308 may be generated for ego vehicle 304 as described further with reference to FIG. 1. Ego vehicle trajectory 308 and/or trajectory 164 may include a polyline trajectory. Ego vehicle trajectory 308 may include one or more trajectory points 312 along which the ego vehicle 304 is supposed to traverse. Ego vehicle trajectory 308 may be generated as a function of the probabilistic occupancy map. For example, in some embodiments, ego vehicle trajectory 308 may include one or more stop points 316 at which ego vehicle 304 may be configured to stop or slow in order to avoid an agent. In some embodiments, one or more trajectory points 312 may have associated speed data or acceleration data, which may be determined as a function of probabilistic occupancy map.

### Exemplary Car Computing System

Referring now to FIGS. 4A and 4B, an exemplary vehicle computing architecture 400 is shown. Vehicle computing architecture 400 may include a vehicle 405. A “vehicle,” for the purposes of this disclosure is a device that is designed to transport goods, people, and/or animals. In some embodiments, vehicle 405 may be motorized. As non-limiting examples, vehicle 405 may include a car, a scooter, an ebike, an ATV, a motorcycle, a motorbike, a minibike, a truck, a golf cart, an aircraft, and the like. In some embodiments, vehicle 405 may be human-powered. As non-limiting examples, vehicle 405 may include a bike, a rickshaw, a skateboard, a scooter, or the like.

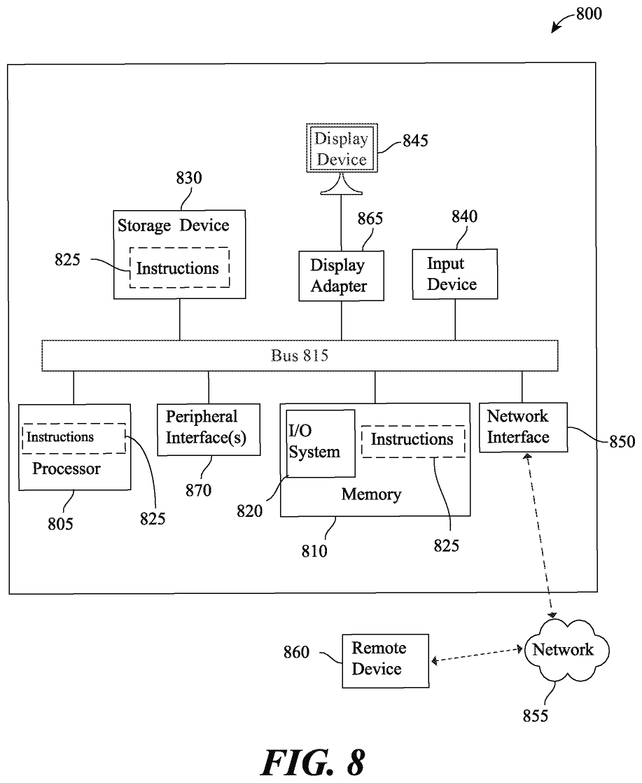

With continued reference to FIGS. 4A AND 4B, the vehicle 405 may be an autonomous vehicle that may drive, navigate, operate, etc. with minimal and/or no interaction from a human driver. Vehicle 405 may include a vehicle computing device 410 that implements a variety of systems on-board the vehicle 405. In some embodiments, vehicle computing device 410 may be consistent with aspects of computing device 800 described further with respect to FIG. 8.

With continued reference to FIGS. 4A and 4B, in some embodiments, vehicle computing architecture 400 may include one or more data acquisition systems 415. A data acquisition systems 415 may include a plurality of sensors configured to detect data from the environment surrounding or inside of vehicle 405. In some embodiments, data acquisition system 415 may include one or more cameras. Cameras may include, as non-limiting examples, wide-angle cameras, high-resolution cameras, panoramic cameras, two-dimensional cameras, three-dimensional cameras, video cameras, and the like. In some embodiments, data acquisition system 415 may include one or more LIDAR sensors. In some embodiments, data acquisition system 415 may include one or more ultrasound sensors. For example, ultrasound sensors may be mounted around the perimeter of vehicle 405. In some embodiments, ultrasound sensors may be located on the corners of vehicle 405. In some embodiments, ultrasound sensors may be used for object detection and/or collision avoidance. In some embodiments, data acquisition system 415 may include one or more microphones. In some embodiments, microphones may be arranged in an array. In some embodiments, microphones may include directional microphones. In some embodiments, microphones may include unidirectional microphones. In some embodiments data acquisition system 415 may include one or more RADAR sensors. In some embodiments, data acquisition system 415 may include, as non-limiting examples, lane detectors, optical readers, electric eyes, and/or other suitable types of image capture devices.

With continued reference to FIGS. 4A and 4B, vehicle computing device 410 may include a plurality of vehicle computing devices 410. As a non-limiting example, in some embodiments, vehicle computing device 410 may include, a central computing device and one or more auxiliary computing devices. In some embodiments, auxiliary computing devices may be located on or in the vehicle 405 roof. In some embodiments, auxiliary computing devices may be located close to certain sensors of data acquisition system 415 that they are configured to process data for. For example, auxiliary computing devices configured to process camera data may be located near cameras. For example, auxiliary computing devices configured to process LIDAR data may be located near LIDAR sensors. This may serve, for example, as an edge computing implementation, wherein, for example, data processing for certain sensors or sources of data may be offloaded to auxiliary computing devices that are closer to the sensors of sources of data of interest. This may beneficially impact data processing as it allows for data to be processed sooner after it is collected.

With continued reference to FIGS. 4A and 4B, the vehicle 405 may be configured to enter into a ready state. The ready state may indicate that the vehicle 405 is ready to operate (and/or return to) an autonomous navigation mode. A computing device on-board the vehicle 405 may be configured to determine whether the vehicle 405 is in the ready state. A remote computing device 420 (e.g., associated with an operations control center) may indicate that the vehicle 405 is ready to begin and/or resume autonomous navigation.

With continued reference to FIGS. 4A and 4B, for instance, the vehicle computing system 410 may include a communications system 425, one or more manual interface systems 430, one or more data acquisition systems 415, an autonomy command 435, one or more operational control components 440, and/or a manual control system 445.

With continued reference to FIGS. 4A and 4B, the manual interface systems 430 may be configured to allow interaction between a user (e.g., human) and the vehicle 405 (e.g., the vehicle computing system 410). The manual interface systems 430 may include a variety of interfaces for the user to input and/or receive information from the vehicle computing system 410. The manual interface systems 430 may include one or more input device(s) (e.g., touchscreens, keypad, touchpad, knobs, buttons, sliders, switches, mouse, gyroscope, microphone, other hardware interfaces) configured to receive user input. The manual interface systems 430 may include a user interface (e.g., graphical user interface, conversational and/or voice interfaces, chatter robot, gesture interface, other interface types) for receiving user input.

With continued reference to FIGS. 4A and 4B, vehicle computing system 410 may include a processor 450 and a memory 455. Processor 450 and memory 455 may be consistent with other processors and memory described throughout this disclosure. Processor 450 and memory 455 may be communicatively connected. Memory 455 may contain instructions (e.g., software) configured to cause processor 450 to perform one or more actions in accordance with this disclosure.

With continued reference to FIGS. 4A and 4B, vehicle computing architecture 400 may include a remote computing device 420. the remote computing device 420 may include and/or otherwise be associated with one or more computing devices (e.g., computing device 800 referred to in FIG. 8 that are remote from the vehicle 405. The remote computing device 420 may communicate with the vehicle 405 via one or more communications networks 460. The communications network 460 may include various wired and/or wireless communication mechanisms (e.g., cellular, wireless, satellite, microwave, and radio frequency) and/or any desired network topology. For example, the communications network 460 may include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 405.

### Exemplary Machine-Learning Module and Neural Network

Referring now to FIG. 5, an exemplary embodiment of a machine-learning module 500 is shown. Machine-learning module 500 may be configured to perform one or more machine learning processes as described throughout this disclosure. Machine-learning module 500 may perform determinations, classification, and/or analysis steps, methods, processes, or the like as described in this disclosure using machine learning processes. A “machine learning process,” as used in this disclosure, is a process that automatedly uses training data 505 to generate one or more machine-learning models 510.

With continued reference to FIG. 5, for the purposes of this disclosure, “training data” is data that contains correlations that a machine-learning process may use to model relationships between two or more types of data. For example, training data 505 may include one or more training examples. Multiple data entries in training data 505 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. In some embodiments, training data 505 may include input training data correlated to output training data. Input training data may include, as a non-limiting example telemetry data, position data, and/or probabilistic occupancy maps as described further throughout this disclosure. Output training data may include, as a non-limiting example, ground truth or observed trajectories, as described further throughout this disclosure. Elements in training data 505 may be linked to descriptors of categories by tags, tokens, or other data elements; for instance, and without limitation, training data 505 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 5, in some embodiments, training data 505 may be divided into different formats, categories, and/or groups. For example, in some embodiments, training data 505 may be divided into one or more cohorts, categorizations, time periods, data sources, and the like. In some embodiments, training data 505 may be assigned to categories using a classifier; as a non-limiting example, a training data classifier. Training data classifier may include a machine-learning module as described elsewhere with respect to FIG. 5. For example, in some embodiments, training data 505 may be input into training data classifier and training data classifier may output a classification. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 500 may generate a classifier using a classification algorithm, defined as a processes whereby a computing device and/or any module and/or component operating thereon derives a classifier from training data 505. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. In some embodiments, training data 505 may be classified into one or more categories such as types of vehicle or geographic locations.

With continued reference to FIG. 5, training data 505 may be retrieved, in some embodiments, from a data structure 515. A data structure 515 may be remote to a computing device and communicative with a computing device by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure a computing device connect directly, dynamically, and non-hierarchically to as many other computing devices as possible. A “network topology” as used in this disclosure is an arrangement of elements of a communication network. data structure 515 may be implemented, without limitation, as a relational database, a key-value retrieval database such as a NOSQL database, or any other format or structure for use as a database that a person skilled in the art would recognize as suitable upon review of the entirety of this disclosure. data structure 515 may alternatively or additionally be implemented using a distributed data storage protocol and/or data structure, such as a distributed hash table or the like. data structure 515 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, data structure 515 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain. In some embodiments, training data 505 may be stored in data structure 515. In some embodiments, training data 505 may be retrieved from data structure 515.

With continued reference to FIG. 5, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

With continued reference to FIG. 5, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

With continued reference to FIG. 5, a “machine-learning model,” as used in this disclosure, is a data structure representing and/or instantiating a mathematical and/or algorithmic representation of a relationship between inputs and outputs as generated using any machine-learning process. For example, machine-learning process may include, without limitation, any machine-learning process described in this disclosure.

With continued reference to FIG. 5, machine-learning process may include an unsupervised machine-learning process 520. An unsupervised machine-learning process, as used herein, is a process that derives inferences in datasets without regard to labels; as a result, an unsupervised machine-learning process may be free to discover any structure, relationship, and/or correlation provided in the data. Unsupervised processes machine-learning process 520 may not require a response variable; unsupervised processes machine-learning process 520 may be used to find interesting patterns and/or inferences between variables, to determine a degree of correlation between two or more variables, or the like.

With continued reference to FIG. 5, machine-learning process may include a supervised machine-learning process 525. Supervised machine-learning process 525 may use training data 505 with both exemplary inputs and expected outputs and use that training data 505 to train a machine-learning model 510. For example, during a training process, machine learning process may evaluate an actual output generated by machine-learning model 510 and compare it to an expected output from training data 505. Based on the difference between the actual and expected outputs, one or more weights within machine-learning model 510 may be updated. For example, in some cases a scoring function may be used to train machine-learning model 510. Scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 505.

With continued reference to FIG. 5, machine-learning process may include a lazy-learning process 530. Lazy learning is a machine-learning approach in which the model delays generalization until a query is made. For example, this can be rather than learning a global model during training. Instead of building an abstract representation of the data up front, a lazy learner may store the training instances and wait until it needs to make a prediction. For example, when a new input arrives, the system may perform computation on the fly. Because no heavy training occurs in advance, lazy-learning algorithms may be fast to set up but can be computationally expensive at prediction time and often require storing large datasets in memory. An example may include k-nearest neighbors (k-NN), which classifies new points based on the labels of their closest neighbors in the stored data. Lazy learning may adapt naturally to new data because the “model” is effectively the dataset itself, but this also means it can be sensitive to noise and may not scale well with very large datasets.

With continued reference to FIG. 5, in some embodiments, machine-learning module 500 may receive external feedback 535. External feedback 535 may include, as a non-limiting example, feedback received from a user. In some embodiments, external feedback 535 may be received through a user interface (such as, for example, a graphical user interface (GUI).

With continued reference to FIG. 5, machine-learning module 500 may be configured to re-train machine-learning model 510. In some embodiments, re-training machine-learning model 510 may include re-training machine-learning model 510 as a function of external feedback 535. In some embodiments, external feedback 535 may serve as a source of labeled or partially labeled data that reflects how the model performs in real-world conditions.

For example, if a user provides negative external feedback 535, then the set of data from training data 505 may be assigned a negative label. In some embodiments, external feedback 535 may include users correcting an output 540 of machine-learning model 510—such as flagging an incorrect prediction, choosing a preferred recommendation, or providing explicit labels. These interactions can be collected and added back into the training dataset. Over time, this additional data may help the model adapt to new patterns, correct systematic errors, and better align with user expectations. The re-training process may include cleaning and validating external feedback 535, merging it with existing datasets such as training data 505, and/or periodically running a new training cycle to update model parameters.

With continued reference to FIG. 5, machine-learning module 500 may be configured to validate machine-learning model 510. In some embodiments, machine-learning module 500 may validate machine-learning model 510 using validation data 545. Validation data 545 may be a subset of data used to train machine-learning model 505. For example, validation data 545 may include a subset of training data 505. In some embodiments, validation data 545 may include a percentage of training data 505. As non-limiting example, validation data 545 may include 1%, 2%, 5%, 10%, 20%, 30%, and the like of training data 505. In some embodiments, machine-learning model 510 may not be exposed to validation data 545 during training. Validation data 545 may acts as a checkpoint that helps determine whether the model is generalizing well or simply memorizing training data 505. As the model learns, its performance on the validation set may be monitored to guide decisions such as choosing hyperparameters, selecting architectures, adjusting regularization strength, or determining when to stop training to avoid overfitting.

With continued reference to FIG. 5, machine-learning model 510 may be configured to receive one or more inputs 550 and generate, as a function of the one or more inputs 550, one or more outputs 540. Outputs 540 may be presented to users for example trough user interfaces and/or GUIs. In some embodiments, external feedback 535 may be received users as a function of output 540.

With continued reference to FIG. 5, one or more, processes, machine-learning processes, actions, steps, or the like as disclosed above may be performed using dedicated hardware 555. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware 555 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware 555 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware 555 to perform one or more operations described herein, such as evaluation of model and/or algorithm outputs, one-time or iterative updates to parameters, coefficients, weights, and/or biases, and/or any other operations such as vector and/or matrix operations as described in this disclosure.

Referring now to FIG. 6, an exemplary embodiment of neural network 600 is illustrated. A neural network 600 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 605, one or more intermediate layers 610, and an output layer of nodes 615. Connections between nodes may be created using a process of “training” the network, in which elements from a training dataset may applied to the input nodes. A suitable training algorithm (such as Levenberg-Marquardt, conjugate gradient, simulated annealing, or other algorithms) may then be used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

### Exemplary Method for Probabilistic Motion Planning in Autonomous Vehicles

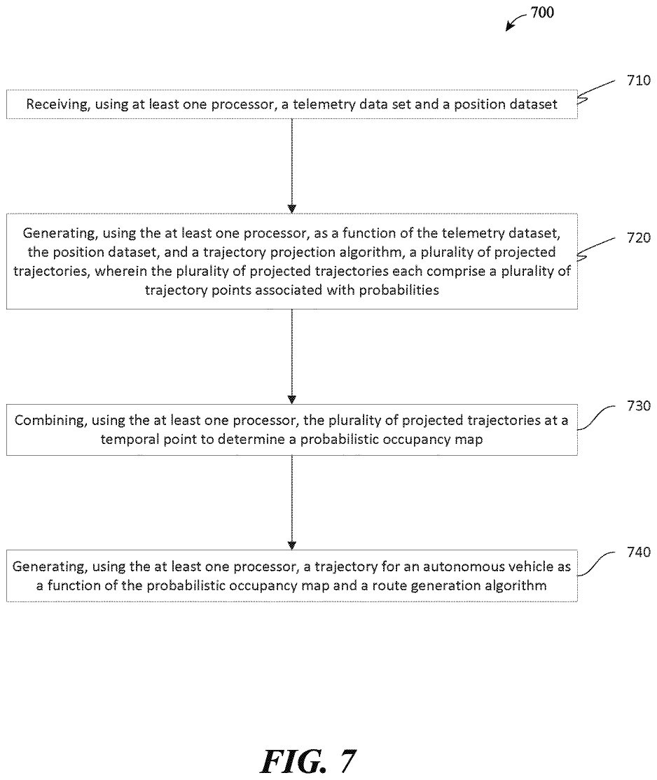

Referring now to FIG. 7, an exemplary method 700 for probabilistic motion planning in autonomous vehicles is shown. Method 700 includes a step 710 of receiving, using at least one processor, a telemetry data set and a position dataset. This may be performed, without limitation, as described with reference to any of FIGS. 1-6.

With continued reference to FIG. 7, exemplary method 700 includes a step 720 of generating, using the at least one processor, as a function of the telemetry dataset, the position dataset, and a trajectory projection algorithm, a plurality of projected trajectories, wherein the plurality of projected trajectories may each include a plurality of trajectory points associated with probabilities. This may be performed, without limitation, as described with reference to any of FIGS. 1-6.

With continued reference to FIG. 7, exemplary method 700 includes a step 730 of combining, using the at least one processor, the plurality of projected trajectories at a temporal point to determine a probabilistic occupancy map. This may be performed, without limitation, as described with reference to any of FIGS. 1-6.

With continued reference to FIG. 7, exemplary method 700 includes a step 740 of generating, using the at least one processor, a trajectory for an autonomous vehicle as a function of the probabilistic occupancy map and a route generation algorithm. This may be performed, without limitation, as described with reference to any of FIGS. 1-6.

In some aspects, the techniques described herein relate to a method, wherein the plurality of projected trajectories includes polyline trajectories.

In some aspects, the techniques described herein relate to a method, wherein generating the trajectory for the autonomous vehicle as a function of the probabilistic occupancy map includes: generating the trajectory for the autonomous vehicle; and checking the trajectory for the autonomous vehicle against probabilities associated with one or more segments of the probabilistic occupancy map.

In some aspects, the techniques described herein relate to a method, wherein checking the trajectory for the autonomous vehicle against probabilities associated with the one or more segments of the probabilistic occupancy map includes: determining a plurality of intersected segments of the probabilistic occupancy map that are intersected by the trajectory; and adjusting the trajectory against the probabilities associated with the plurality of intersected segments.

In some aspects, the techniques described herein relate to a method, further including presenting, using the at least one processor, the probabilistic occupancy map to a user through a display device.

In some aspects, the techniques described herein relate to a method, wherein receiving the telemetry data set and the position dataset includes receiving the telemetry data set and the position dataset from a vehicle sensor set.

In some aspects, the techniques described herein relate to a method, wherein the autonomous vehicle includes an autonomous car.

In some aspects, the techniques described herein relate to a method, wherein the autonomous vehicle includes a delivery robot.

In some aspects, the techniques described herein relate to a method, wherein generating, as a function of the telemetry dataset, the position dataset, and the trajectory projection algorithm, the plurality of projected trajectories includes generating the associated probabilities of the plurality of trajectory points using a Gaussian Mixture Model.

In some aspects, the techniques described herein relate to a method, wherein generating a trajectory for the autonomous vehicle as a function of the probabilistic occupancy map and the route generation algorithm includes assigning a cost to an element of the probabilistic occupancy map as a function of the probabilities.

### Exemplary Computing Device

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 805 and a memory 810 that communicate with each other, and with other components, via a bus 815. Bus 815 may include any of several types of bus structures including, but not limited to, a memory bus, a memory controller, a peripheral bus, a local bus, and any combinations thereof, using any of a variety of bus architectures.

Processor 805 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 805 may be organized according to Von Neumann and/or Harvard architecture as a non-limiting example. Processor 805 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 810 may include various components (e.g., machine-readable media) including, but not limited to, a random-access memory component, a read only component, and any combinations thereof. In one example, a basic input/output system 820 (BIOS), including basic routines that help to transfer information between elements within computer system 800, such as during start-up, may be stored in memory 810. Memory 810 may also include (e.g., stored on one or more machine-readable media) instructions (e.g., software) 825 embodying any one or more of the aspects and/or methodologies of the present disclosure. In another example, memory 810 may further include any number of program modules including, but not limited to, an operating system, one or more application programs, other program modules, program data, and any combinations thereof. Memory 810 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 800 may also include a storage device 830. Examples of a storage device (e.g., storage device 830) include, but are not limited to, a hard disk drive, a magnetic disk drive, an optical disc drive in combination with an optical medium, a solid-state memory device, and any combinations thereof. Storage device 830 may be connected to bus 815 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 830 (or one or more components thereof) may be removably interfaced with computer system 800 (e.g., via an external port connector (not shown)). Particularly, storage device 830 and an associated machine-readable medium may provide nonvolatile and/or volatile storage of machine-readable instructions, data structures, program modules, and/or other data for computer system 800. In some embodiments, storage device 830 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 825) may reside, completely or partially, within machine-readable medium. In another example, software may reside, completely or partially, within processor 805.

Computer system 800 may also include an input device 840. In one example, a user of computer system 800 may enter commands and/or other information into computer system 800 via input device 840. Examples of an input device 840 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 840 may be interfaced to bus 815 via any of a variety of interfaces (not shown) including, but not limited to, a serial interface, a parallel interface, a game port, a USB interface, a FIREWIRE interface, a direct interface to bus 815, and any combinations thereof. Input device 840 may include a touch screen interface that may be a part of or separate from display 845, discussed further below. Input device 840 may be utilized as a user selection device for selecting one or more graphical representations in a graphical interface as described above.

A user may also input commands and/or other information to computer system 800 via storage device 830 (e.g., a removable disk drive, a flash drive, etc.) and/or network interface device 850. A network interface device, such as network interface device 850, may be utilized for connecting computer system 800 to one or more of a variety of networks, such as network 855, and one or more remote devices 860 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data neitwork associated with a telephone/voice provider (e.g., a mobile communications provider data and/or voice network), a direct connection between two computing devices, and any combinations thereof. A network, such as network 855, may employ a wired and/or a wireless mode of communication. In general, any network topology may be used. Information (e.g., data, software, etc.) may be communicated to and/or from computer system 800 via network interface device 850.

Computer system 800 may further include a video display adapter 865 for communicating a displayable image to a display device, such as display 845. Examples of a display device include, but are not limited to, a liquid crystal display (LCD), a cathode ray tube (CRT), a plasma display, a light emitting diode (LED) display, and any combinations thereof. Display adapter 865 and display 845 may be utilized in combination with processor 805 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 815 via a peripheral interface 870. Examples of a peripheral interface include, but are not limited to, a serial port, a USB connection, a FIREWIRE connection, a parallel connection, and any combinations thereof.

Further referring to FIG. 8, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 8, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 8, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 800, processor 805, and memory 810 may be virtualized; that is, a virtual machine and/or container may interact directly with such computing system 800, processor 805, and/or memory 810, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 805 comprises a plurality of processors and/or processor cores, virtualization may, in some cases, simulate or emulate a single (virtual) processor whose functions are allocated to one or more of the plurality of processors and/or processor cores. In this case, while processor 805 may be said to be virtualized, the processor 805, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular method and systems used to implement the probabilistic motion planning may be modified without changing the spirit of the disclosure, and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for probabilistic motion planning in autonomous vehicles, the system comprising:
at least one processor; and
a memory communicatively connected to the at least one processor, wherein the memory contains instructions configuring the at least one processor to:
receive a telemetry data set and a position dataset;
generate as a function of the telemetry dataset, the position dataset, and a trajectory projection algorithm, a plurality of projected trajectories, wherein the plurality of projected trajectories each comprise a plurality of trajectory points associated with probabilities;
combine the plurality of projected trajectories at a temporal point to determine a probabilistic occupancy map; and
generate a trajectory for an autonomous vehicle as a function of the probabilistic occupancy map and a route generation algorithm.

2. The system of claim 1, wherein the plurality of projected trajectories comprises polyline trajectories.

3. The system of claim 1, wherein generating the trajectory for the autonomous vehicle as a function of the probabilistic occupancy map comprises:
generating the trajectory for the autonomous vehicle; and
checking the trajectory for the autonomous vehicle against probabilities associated with one or more segments of the probabilistic occupancy map.

4. The system of claim 3, wherein checking the trajectory for the autonomous vehicle against probabilities associated with the one or more segments of the probabilistic occupancy map comprises:
determining a plurality of intersected segments of the probabilistic occupancy map that are intersected by the trajectory; and
adjusting the trajectory against the probabilities associated with the plurality of intersected segments.

5. The system of claim 1, wherein the memory contains instructions further configuring the at least one processor to present the probabilistic occupancy map to a user through a display device.

6. The system of claim 1, wherein receiving the telemetry data set and the position dataset comprises receiving the telemetry data set and the position dataset from a vehicle sensor set.

7. The system of claim 1, wherein the autonomous vehicle comprises an autonomous car.

8. The system of claim 1, wherein the autonomous vehicle comprises a delivery robot.

9. The system of claim 1, wherein generating, as a function of the telemetry dataset, the position dataset, and the trajectory projection algorithm, the plurality of projected trajectories comprises generating the associated probabilities of the plurality of trajectory points using a Gaussian Mixture Model.

10. The system of claim 1, wherein generating a trajectory for the autonomous vehicle as a function of the probabilistic occupancy map and the route generation algorithm comprises assigning a cost to an element of the probabilistic occupancy map as a function of the probabilities.

11. A method for probabilistic motion planning in autonomous vehicles, the method comprising:
receiving, using at least one processor, a telemetry data set and a position dataset;
generating, using the at least one processor, as a function of the telemetry dataset, the position dataset, and a trajectory projection algorithm, a plurality of projected trajectories, wherein the plurality of projected trajectories each comprise a plurality of trajectory points associated with probabilities;
combining, using the at least one processor, the plurality of projected trajectories at a temporal point to determine a probabilistic occupancy map; and
generating, using the at least one processor, a trajectory for an autonomous vehicle as a function of the probabilistic occupancy map and a route generation algorithm.

12. The method of claim 11, wherein the plurality of projected trajectories comprises polyline trajectories.

13. The method of claim 11, wherein generating the trajectory for the autonomous vehicle as a function of the probabilistic occupancy map comprises:
generating the trajectory for the autonomous vehicle; and
checking the trajectory for the autonomous vehicle against probabilities associated with one or more segments of the probabilistic occupancy map.

14. The method of claim 13, wherein checking the trajectory for the autonomous vehicle against probabilities associated with the one or more segments of the probabilistic occupancy map comprises:
determining a plurality of intersected segments of the probabilistic occupancy map that are intersected by the trajectory; and
adjusting the trajectory against the probabilities associated with the plurality of intersected segments.

15. The method of claim 11, further comprising presenting, using the at least one processor, the probabilistic occupancy map to a user through a display device.

16. The method of claim 11, wherein receiving the telemetry data set and the position dataset comprises receiving the telemetry data set and the position dataset from a vehicle sensor set.

17. The method of claim 11, wherein the autonomous vehicle comprises an autonomous car.

18. The method of claim 11, wherein the autonomous vehicle comprises a delivery robot.

19. The method of claim 11, wherein generating, as a function of the telemetry dataset, the position dataset, and the trajectory projection algorithm, the plurality of projected trajectories comprises generating the associated probabilities of the plurality of trajectory points using a Gaussian Mixture Model.

20. The method of claim 11, wherein generating a trajectory for the autonomous vehicle as a function of the probabilistic occupancy map and the route generation algorithm comprises assigning a cost to an element of the probabilistic occupancy map as a function of the probabilities.
